(19) United States
(12) Patent Application Publication
(10) Pub. No.: US 2008/0306880 A1
(43) Pub. Date: Dec. 11, 2008

(54) SYSTEM AND METHOD FOR CREATING A PRIMARY AND SECONDARY MARKET IN WHOLE AND BIFURCATED LAND TENANT IN COMMON REAL PROPERTY OWNERSHIP INTERESTS

(76) Inventor: Alan W. Legatz, Naples, FL (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 11/782,437

(22) Filed: Jul. 24, 2007

Related U.S. Application Data
(63) Continuation-in-part of application No. 11/758,737, filed on Jun. 6, 2007.

(51) Int. Cl. G06Q 40/00

(52) U.S. Cl. 705/36 R

(57) ABSTRACT

The present invention relates to systems, methods, and articles of manufacture for the exchange of tenant in common real property ownership interests, either by physical or electronic exchange. The present invention also relates to methods for creating a secondary market for the buying and selling of tenant in common real property ownership interests. Additionally, the present invention relates to the creation of a primary and secondary market in bifurcated land TIC agreements.

### CROSS REFERENCE TO RELATED APPLICATIONS

The present application is a continuation-in-part and claims the benefit under 35 U.S.C. §120 to U.S. patent application Ser. No. 11/758,737, filed Jun. 6, 2007, which is expressly incorporated fully herein by reference.

### FIELD OF THE INVENTION

The present invention relates to the monetization of land using tenant in common real property ownership interests. Specifically, the present invention relates to creating a primary market in tenant in common (TIC) real property ownership interests using a bifurcated land TIC agreement. Additionally, the present invention relates to creating a secondary market in deeded TIC real property ownership interests. These interests may comprise a traditional “slice of a whole” TIC investment comprising vacant land, surface and subsurface mineral rights, and improved land. Alternatively, these interests may be unimproved land from which all land improvement assets have been legally bifurcated. Additionally, the transaction may include a type of insurance policy to guarantee land rent to the owners of the unimproved land interests. Moreover, the market may be a traditional physical market in a specific location. The market may also be an electronic one, comprising one or more computer programs and an electronic data network.

### BACKGROUND OF THE INVENTION

Real estate is attractive as an investment because traditionally it has tended to appreciate over the long term. However, one drawback to land as an investment, prior to the present invention, is that land has been a somewhat illiquid investment. Therefore, land is generally purchased for a specific use. For example, land may be purchased for building structures upon it, for residential, commercial, or industrial uses. Examples of such structures are single-family homes or high-density housing; offices or retail stores; foundries, factories, mills, mines, and oil drilling facilities. Land may be purchased for agricultural purposes, such as farming, ranching, timber, or aquaculture. Alternatively, land may be purchased with the intent of developing for recreational purposes; e.g., for resorts, ski resorts, casinos, race tracks, camps, amusement parks, golf courses, tennis courts, and so on.

Therefore, for instance, if one buys a plot of land and builds an apartment complex on it, the cost of the land is merely part of the cost of the commercial apartment project. The land, and the cost of this property, has been committed to that commercial dwelling purpose.

This type of investment creates two separate liquidity problems. The first is that the buyer in the apartment building project will have a large amount of capital invested in the price of the land. Normally, he cannot easily recover the cost of the land unless he sells the entire project. The second problem is that other buyers cannot invest in the land, because it has been committed for use in that particular project. There is currently no mechanism in place to invest in the land separately from the land improvements and still have a liquid investment.

Traditionally, buyers have attempted to recover capital investment in real estate projects using a leaseback arrangement. In a leaseback arrangement, the primary buyer buys land and develops it for a use he needs. Once the building project is finished, the primary buyer sells the property to a secondary buyer, and then leases the property back. This allows the primary buyer to regain the capital invested, and allows the land to be used for its intended purpose. Additionally, this allows the secondary buyer to invest in a project that has already been completed and already has a stable tenant. This type of arrangement is very common in the area of “big box” retail, in which a retailer develops the project, sells it to a secondary buyer, and then leases the building back from the secondary buyer to run the retail business.

In addition to allowing the primary buyer to recover capital, these leaseback arrangements may also provide certain tax benefits. Because the lease is now considered a business expense for the primary buyer, it is generally tax deductible, subject to the laws and regulations applicable in that locale. However, these leaseback arrangements tend to be an all-or-nothing type of investment. In other words, the secondary buyer must be able to buy the entire property, as opposed to a fractional interest in it. Also, in some cases, the IRS disallows the rent deduction because they deem the leaseback to be long-term financing disguised as a lease.

Another option for making land liquid is a tenancy in common (TIC) agreement. In this arrangement, multiple buyers buy TIC ownership interests in a single real property. This allows buyers to buy a fractional interest in real estate and then receive a pro rata share of any income derived from it. TIC buyers may also be entitled to a pro rata share of property depreciation, maintenance costs, or other expenses for tax purposes. TIC agreements can pertain to the actual land, or to other assets related to the land such as mineral rights or structures built upon the land.

In the past, however, TIC investments also have been somewhat illiquid for several reasons. All TIC agreements require a buyer to sign the TIC agreement upon acquisition. However, in the past, some TIC agreements required right of first refusal, or at least first approval, by the remaining TIC owners when one owner wants to sell his interest. This means that if a buyer wants to sell his interest in the TIC, he has to first offer it to the other TIC owners. Then, even if the other owners decline to purchase the interest, the new buyer has to be approved by a unanimous (or sometimes majority) vote of the remaining TIC owners.

A second hindrance to the liquidity of TIC investments has been the classification by the Security and Exchange Commission (SEC) of these investments as securities, subject to SEC regulations. Because the land improvement assets often require management, the success of the investment is largely dependent on the “efforts of others.” This tends to lead the SEC to classify an investment as a security. Regulation by the SEC increases the complexity of transacting in this type of investment. This complexity has traditionally deterred greater offerings of, and investment in, TICs by the public.

Thirdly, there is not an organized and accurate secondary market in TIC investments. The current market in TIC investments is fractionalized, with TIC investments generally only being sold by each individual promoter and a handful of agents. Buyers are wary of fractionalized markets as there is no ready source for unbiased information upon which to base investment decisions and no ready market for subsequent sales. Additionally, due to a history of some degree of impropriety in the TIC industry, buyers tend to think of TIC investments as an investment “scheme” rather than a solid investment.

The present invention addresses all of these concerns by creating a primary and secondary market in TIC real property ownership interests in which the land (including surface and subsurface mineral rights) has been legally bifurcated from any land improvements. Additionally, the present invention creates an organized and centralized exchange in investments in slice of a whole TIC real property ownership interests. The present system therefore provides several avenues for investment: a primary market in bifurcated land TIC investments, and an organized secondary market in bifurcated land TIC investments, and an organized secondary market in a slice of a whole TIC investments.

In the area of bifurcated TIC investments, an additional investment is created by adding a type of insurance policy to the transaction. The insurance policy is purchased from a third-party guarantor to guarantee rent payment to the bifurcated landowners if the land improvement asset owner is unable to meet his rent obligations. The policy guarantees the payment of rent to the bifurcated landowners for a period specified in the policy.

Upon the expiration of this period, the third-party guarantor has the first right of refusal to buy the land improvement asset from the bank under the terms set forth in the policy. Additionally, the third-party guarantor may have the option to purchase the bifurcated land from the landowners. However, if the third-party guarantor does not wish to purchase the land improvement asset, the bifurcated landowners may also have the right to purchase the land improvement asset from the bank under the terms set forth in the agreement.

In return for the added security provided by such a policy, the landowners may be willing to pledge a portion of the land to secure the loan for the land improvement asset. This allows the land improvement asset owner to obtain a larger loan and build a more expensive land improvement asset. This, in turn, may allow the land improvement asset owner to charge more rent and, consequently, pay more rent to the landowners.

### SUMMARY OF THE INVENTION

The present invention relates to the monetization of land using tenant in common real property ownership interests. Specifically, the present invention involves methods comprising obtaining an insurance policy that guarantees land rent payments from the owners of a land improvement asset to the owners of bifurcated land TIC interests on land subject to a bifurcated land TIC agreement. In one embodiment, this insurance policy may be purchased from a third-party guarantor by one or more parties selected from the group consisting of land improvement asset owners, bifurcated land TIC interest owners, and funding providers.

The third-party guarantor may comprise one or more entities selected from the group consisting of real estate brokerages, investment banks, insurance companies, and pension funds. Also, the third-party guarantor may have the option to purchase the land improvement asset for the remaining loan balance when the land improvement asset owner fails to pay the land rent for a period specified in the policy. Additionally, the third-party guarantor may have the option to purchase the bifurcated land TIC interests for the original purchase price plus, for example, a fixed annual percentage rate after exercising the option to purchase the land improvement asset. The bifurcated land TIC interest owners may have the option to purchase the land improvement asset for the remaining loan balance when the third-party guarantor declines to exercise the option to buy the land improvement asset.

One embodiment of the present invention involves methods comprising obtaining financing for a land improvement asset on land subject to a bifurcated land TIC agreement, where the land improvement asset is subject to a land lease on the land; and obtaining an insurance policy that insures land rent payments from the owners of the land improvement asset to owners of the bifurcated land TIC interests. This insurance may come into effect in the event there is a default on the funding or a failure to pay the rent by the land improvement asset owner. In another embodiment, the financing may be secured using the land improvement asset and up to about 50 percent of the value of the bifurcated land TIC interests.

This insurance policy may be purchased from a third-party guarantor by one or more parties selected from the group consisting of land improvement asset owners, bifurcated land TIC interest owners, and funding providers. Additionally, the third-party guarantor may be one or more entities selected from the group consisting of real estate brokerages, investment banks, insurance companies, and pension funds. In yet another embodiment, the third-party guarantor may have the option to purchase the land improvement asset for the remaining loan balance if the land improvement asset owner fails to pay the land rent for a period specified in the policy.

In still another embodiment, the third-party guarantor may have the option to purchase the bifurcated land TIC interests for the original purchase price plus a fixed annual percentage after purchasing the land improvement asset for the remaining loan balance. Alternatively, the bifurcated land TIC interest owners may have the option to purchase the land improvement asset for the remaining loan balance if the third-party guarantor declines to exercise the option to purchase the land improvement asset.

The present invention also encompasses methods comprising selling an insurance policy that guarantees land rent payments from the owners of a land improvement asset to owners of bifurcated land TIC interests on land subject to a bifurcated land TIC agreement. In one embodiment, the insurance policy may be sold by a third-party guarantor to one or more parties selected from the group consisting of land improvement asset owners, bifurcated land TIC interest owners, and funding providers. Furthermore, the third-party guarantor may comprise one or more entities selected from the group consisting of real estate brokerages, investment banks, insurance companies, and pension funds.

In a further embodiment, the third-party guarantor may have the option to purchase the land improvement asset for the remaining loan balance when the land improvement asset owner fails to pay the land rent for a period specified in the policy. Furthermore, the third-party guarantor may have the option to purchase the bifurcated land TIC interests for the original purchase price plus a fixed annual percentage rate after exercising the option to purchase the land improvement asset. Finally, the bifurcated land TIC interest owners may have the option to purchase the land improvement asset for the remaining loan balance when the third-party guarantor declines to exercise the option to buy the land improvement asset.

### BRIEF DESCRIPTION OF THE DRAWING

FIG. 1 is a flow chart showing the exemplary step of offering a BaLTIC investment for the first time using the primary side of the market.

FIG. 2 is a flow chart showing the exemplary steps involved when a buyer makes a bid on a BaLTIC investment using the secondary side of the market.

FIG. 3 is a flow chart showing what happens when a buyer and a seller have a meeting of the minds and there is a sale or trade of a BaLTIC investment over the CTTS.

FIG. 4 is a flow chart showing exemplary steps involved in a seller making a TIC investment available over a centralized TIC trading system (CTTS).

FIG. 5 is a flow chart showing exemplary steps involved in a buyer making an offer for a TIC investment over a CTTS.

FIG. 6 is a flow chart showing exemplary steps involved when a buyer and a seller have a “meeting of the minds” and a transaction is successful on the CTTS.

FIG. 7 shows various components of a traditional “brick and mortar” type of exchange using an open outcry type of auction system.

FIG. 8 shows the structure of a TIC investment involving a third-party guarantor.

### DETAILED DESCRIPTION OF THE INVENTION

It is understood that the present invention is not limited to the particular methodologies, protocols, systems and methods, etc., described herein, as these may vary. It is also to be understood that the terminology used herein is used for describing particular embodiments only, and is not intended to limit the scope of the present invention. It must be noted that as used herein and in the appended claims, the singular forms “a,” “an,” and “the” include the plural reference unless the context clearly dictates otherwise. For instance, a reference to a sensor refers to one or more sensors and a reference to “a system” is a reference to one or more systems and includes equivalents thereof known to those skilled in the art and so forth.

Unless defined otherwise, all technical and scientific terms used herein have the same meanings as commonly understood by one of ordinary skill in the art to which this invention belongs. Specific methods, devices, systems, and materials are described, although any methods and materials similar or equivalent to those described herein can be used in the practice or testing of the present invention. The definitions that follow are not meant to be limiting in nature, but serve to provide a clearer understanding of certain aspects of the present invention.

The term “investment,” as used herein, relates to the choice made by the buyer to commit money, currency or other funds in transactions including those typically utilized in trading real property or the whole or fractional interests therein, or trading of the rights associated with such property or interests, e.g. mineral rights. For the purposes of the present invention, the term “buyer” is used throughout where traditionally one might understand “investor”; i.e., the buyer is the party to the transaction who selects the ownership interests offered for sale, and commits funds for their purchase or for investment in them.

As used herein, the term “outcry auction” refers to any auction where the auction is conducted orally for people to hear. This type of auction also refers to what is traditionally used in stock exchanges and commodity exchanges, where trading occurs on a trading floor and traders may enter verbal bids and offers simultaneously. Transactions may take place simultaneously at different places on the trading floor.

As used herein and for the purposes of the present invention, the term “trading floor” refers to the area in a physical exchange where trading of interests takes place. As such, a “trading floor” is a trading venue. This expression often refers to stock exchanges and, more precisely, to the open outcry auction institution where traders or brokers meet in order to buy and sell investments, commodities, real estate interests, etc. The expression “trading floor” may also used to refer to the trading room or dealing room; i.e., the office space where market activities are concentrated in real estate brokerage houses, or other markets. A “trading floor” may also be referred to as a trading pit or ring, or market or exchange floor.

As used herein, the term “put option,” also known as a “put,” refers to a financial contract between two parties, the buyer and the writer of the option (a seller). The put allows the buyer the right but not the obligation to sell the underlying investment to the writer of the option for a certain time for a certain price (the “strike price”). The writer has the obligation to purchase the underlying asset at the strike price, if the buyer exercises the option.

As used herein, the term “call option,” also known as a “call,” refers to a financial contract between two parties, the buyer and the seller, of this type of option. The buyer of the option has the right but not the obligation to buy an agreed quantity of the underlying investment from the seller by a certain date (the expiration date) for a certain price (the strike price). The seller (or “writer”) is obligated to sell the investment should the buyer so decide.

The term “slice of a whole TIC investment” as used herein is defined as interests in a TIC that are a fractional interest of a real estate project including the land and all improvements. Investors are merely buying a slice of the total investment in the project. The term “bifurcated land TIC investment” or “BaLTIC” refers to a TIC investment in which the land has been legally bifurcated from all land improvement assets. As a result, this is a pure land investment, equivalent to an investment in undeveloped land.

The term “land improvement asset owner” is defined to include the actual owner of the land improvement asset and any party who becomes a “lessee” to the BaLTIC owners. In other words, it includes any party that becomes contractually obligated to pay land rent to the BaLTIC owners as part of the BaLTIC agreement. Similarly, the term “BaLTIC owners” is defined as the actual owners of the bifurcated land interests, or any party that becomes a “lessor” of the bifurcated land because of the BaLTIC agreement. Thus, it includes any party that becomes contractually entitled to land rent payments as part of the BaLTIC agreement.

The methods and systems of the present invention may provide real-time market data and communication links to and/or between buyers and sellers. The invention makes possible the monitoring of the value of real property of various types, the receiving of real estate data, the entering of executing of orders, and the storage of the orders. In addition, users of the methods and systems of the present invention may automatically receive confirmations of transaction executions, access static data from a financial information database, and analyze real estate for potential investment using such data and real-time prices.

The present invention creates an organized and centralized market for slice of a whole TIC real property ownership interests. In one embodiment, this system may require that participating TIC agreements be structured such that new buyers do not require the approval of all existing investors. Buyers merely have to complete the existing TIC agreement before taking possession of any TIC shares purchased. While this may have been a cause for owner concern in the past, this is a much more tenable situation when there is a relevant secondary market.

As the liquidity of the market increases, the need to approve all investors in a TIC agreement decreases. For similar reasons, the wariness of investors to enter a TIC agreement diminishes as well. Investors displeased with new or existing investors or investments can merely sell or trade their interests and move on. Moreover, investors can easily assess value and stability for various TIC properties because information and analysis is available through a centralized trading system. A liquid and transparent market may be created similar to the NYSE and NASDAQ for stocks, bonds, and commodities.

This creates a secondary market in whole slice of TIC investments; however, the SEC treats traditional TIC investments as securities. This makes current TIC investments subject to SEC regulations and increases the complexity for buyers and sellers alike, even in an organized secondary marketplace. As a result, the first prong of the present invention provides for the bifurcation of the unimproved land and the surface and subsurface mineral rights (“bifurcated land”) from land improvement assets. This allows fractional interests to be offered in the land alone. These bifurcated land TICs (BaLTICs) should not be considered a security by the SEC, because they are sold separately from the land improvement assets such as buildings, parking structures, oil wells, and the like, that required the “efforts of others”.

When the land is legally bifurcated from the land improvement assets, this type of investment should be deemed a non-security by the SEC. There are also additional benefits related to their taxation. Under Internal Revenue Code §1031, if these BaLTIC interests are traded for “like-kind” interests in other BaLTIC real property ownership interests of the same overall value, there is no recognition of gain or loss by the taxpayer and thus no tax on the transaction. Therefore, investors are able to trade like-kind property for the purposes of diversification, speculation, etc., without paying taxes on each transaction.

Additionally, under Rev. Rul. 2002-22, 2002-19 I.R.B. 849, as long as these TIC agreements do not have more than 35 owners, the TICs will not be taxed at the entity level. In other words, the IRS gives these agreements “pass through” taxation in which only the individual owners are taxed on capital gains. This is in contrast to entity taxation, like in a C Corporation, where the corporation, or entity, is taxed on profits and gains, and then the shareholders are taxed on dividends and gains as well, creating a double taxation problem. In addition, Rev. Rul. 2002-22, 2002-19 I.R.B. 849 only applies to TICS that involve a business interest. However, because the land has been legally bifurcated from all land improvement assets, in a BaLTIC there is no business interest. This should make the 35-investor limitation of Rev. Rul. 2002-22 inapplicable to BaLTICs.

The economic market force that drives the bifurcated land TIC market is that it naturally separates the higher risk of investing in land improvements from the lower risk of owning the underlying land. This separation of risk is not available in the traditional “slice of the whole” TIC investments that include land improvements as well as the underlying land. This more natural separation of investment risk allows security investors that own or want to build the more risky land improvements to receive a higher yield potential because they have leased the land for the building improvements from the bifurcated land TIC investors. These land TIC investors will receive a more conservative and secure return from the land lease payments they receive on their deeded real estate TIC investment.

This lower investment capital cost for land is economically available because the individual land TIC owners can trade their TIC deeds as tax-free real estate under Section 1031 of the Internal Revenue Code at any time in the secondary market. This is so even if the TIC land they own is committed to a long-term lease to the land improvement asset owner(s) or the surface or subsurface mineral deposit exploitation firm(s). For example, one can monetize the land under any structure by creating a bifurcated land TIC where the land TIC owners receive an annual cash return, for example, 6-7.5%, and a modest appreciation factor, for example 3%, if the building improvement owners wish to exercise their option to marry their improvements back to the land at some future date.

However, because this bifurcation step represents new investment technology, it is necessary to create both a primary and a secondary market in BaLTIC real property interests. The primary market is that part of the market that deals with issuing new investments. The present invention is intended to create a primary real estate market similar to that of an initial product offering (IPO) in a securities market.

When a new BaLTIC becomes available, a large investor or an investment bank may underwrite the owner of the BaLTIC. In this case, the underwriter agrees to sell the interests in the BaLTIC in return for a real estate commission, or buys all interests in a BaLTIC at below market value in return for assuming the risk. Alternatively, the BaLTIC may be sold directly to individual investors using the primary side of the real estate market created herein. In either case, the initial offering is made through the centralized market created herein. This market provides real estate investors with a central source for such primary investments.

In another embodiment, the present invention creates a secondary market in BaLTIC real property investments. This allows investors to freely trade interests in BaLTIC investments through a stable, centralized entity. Buyers may buy BaLTIC interests outright, or they may trade interests in various types of allowable like-kind transactions to allow the favorable tax treatment of IRC §1031. This allows market forces to establish a relevant market value for BaLTIC investments. It further provides a central source of information that can be used for various types of market analysis.

By creating a secondary market for TIC investments and a primary and secondary market for BaLTIC investments, the present invention adds capital and raises the value of the TIC market, and the commercial real estate market in general. Firstly, it creates a more stable, liquid market in the traditional or slice of a whole TIC market. This encourages more investors to participate in TIC investments, which, in turn, allows developers and investors in property to recover capital for use in future projects. Secondly, the present invention creates a new stable, liquid primary and secondary market in BaLTIC investments. This allows real estate investors a tax-free investment in land that was previously unavailable due to improvements on the land.

Finally, it allows developers to bifurcate land from land improvements to offer investors two distinct and very different types of investments. The land improvements, oil wells for instance, may be offered to those looking for high risk/high return investments. The unimproved land is more suited to those investors looking for a steady rate of return plus a steadily appreciating investment. All of these features increase the amount of capital available to the real estate developer, which, of course, promotes development.

A further embodiment of the present invention allows for the separation of the land improvement asset, and associated risks, from the land investment. In this embodiment, the land improvement asset owner purchases a special type of insurance policy to pay rent on the bifurcated land to the BaLTIC owners for a period of time in the event the land improvement asset holder is unable to meet his rent obligations. This guarantees the rent on the land and further removes the landowners from the “efforts of others” with respect to the management of the land improvement asset. In return, the insurance provider, or third-party guarantor, receives a premium payment and may have the option to purchase all or part of the land improvement asset and/or all or part of the land if the land improvement asset owner fails to meet his rent obligations.

The trading systems of the present invention may be organized as a physical exchange. This physical exchange could exist in a specified location or locations where buyers and sellers may trade TIC real property ownership interests, similar to the arrangement of traditional brick-and-mortar stock exchanges set up in most developed countries for trading company stocks and securities; e.g., the New York and American Stock Exchanges in the United States. Alternatively, the exchange may exist as an electronic stock exchange, providing an electronic method for buyers and sellers to enter their TIC or BaLTIC real property ownership interest trades, similar to the system provided by the electronic exchange prototype, the NASDAQ.

Further, the exchange may comprise elements of both physical and electronic trading systems. The electronic stock exchange may exist over an electronic data network, such as the internet, and may be an online trading system. Online trading systems are known to those skilled in the art. For example, U.S. patent application Ser. No. 09/825,714 relates to a method for minors to make stock market transactions via the internet; and U.S. Pat. No. 6,773,350 relates to a virtual trading system game that is based on real data, but where no actual trades are made.

It is a further object of the present invention to provide methods and systems to enable individual buyers to select investments in slice of a whole TIC or in BaLTIC real property ownership interests. Yet another object is to encourage individual buyers to participate in the methods and systems of the present invention by allowing the individuals to realize the full gains and losses of their chosen investments, while at the same time providing incentives to invest, such as desirable transaction fees.

As will be appreciated by one of ordinary skill in the art, the electronic exchange embodiment of the present invention may be embodied as a method, a system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program code means embodied in the storage medium. Any suitable computer readable storage medium may be utilized including hard disks, CD-ROMs, optical storage devices, or magnetic storage devices.

The present invention is described below with reference to a block diagram of methods, apparatus (i.e., systems), and computer program products according to an embodiment of the invention. It is understood that each block of the block diagram, and combinations of blocks in the block diagram, respectively, can be implemented by computer program instructions. These computer program instructions may be loaded onto a general-purpose computer, a special purpose computer, or other programmable data processing apparatus to produce a machine, such that the instructions that execute on the computer or other programmable data processing apparatus create means for implementing the functions specified in the diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the diagram block or blocks. The computer program instructions may also be loaded onto a computer or other programmable data processing apparatus to cause a series of operational steps to be performed on the computer or other programmable apparatus so as to produce a computer implemented process, such that the instructions which execute on the computer or other programmable apparatus provide steps for implementing the functions specified in the diagram block or blocks.

Accordingly, blocks of the diagram support combinations of ways for performing the specified functions, combinations of steps for performing the specified functions, and program instruction means for performing the specified functions. It is also understood that each block of the diagram, and combinations of blocks in the block diagram, can be implemented by special purpose hardware-based computer systems that perform the specified functions or steps, or combinations of special purpose hardware and computer instructions.

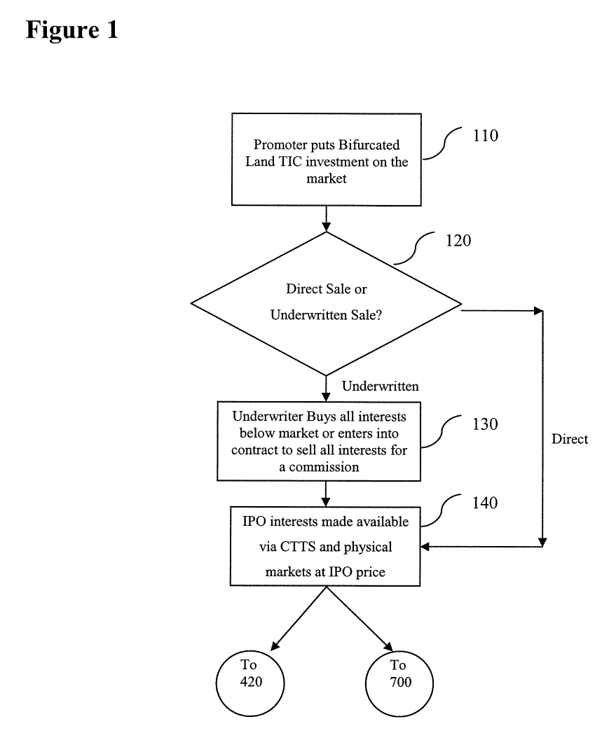

The present invention requires creating a primary market for BaLTICs. See FIG. 1. A primary market is one in which companies, or in this case BaLTIC promoters, make interests available to the public in a sale known as an Initial Public Offering (IPO). They may assume the risk themselves, and sell the interests directly to the public 140. Alternatively, the promoter may use an investment bank or other large investor (the “underwriter”) to buy all of the interests and/or resell them to the public 130. The underwriter either buys the interests below market value or receives a commission, and specifically a real estate commission, on each sale for assuming the risk 130.

In either case, the present invention provides a centralized and organized primary market in which to make an Initial Product Offering (IPO) of real estate investments. Promoters can use the primary market portion of both the electronic and bricks and mortar type market to offer their interests to the public 140. Moreover, because this investment should not be classified as a security, many of the burdens associated with the sale or trade of securities are circumvented (e.g., filing a prospectus, quarterly and yearly earnings reports, etc.). This, unlike in a securities market, allows an IPO to be sold directly to the public and obviates the need for large investment banks and law firms to be involved to insure SEC compliance. However, promoters may still choose to use underwriters to minimize risk.

In addition to creating a primary market, the present invention also creates a secondary market in BaLTICs. This system works in the same manner as the secondary market created for traditional TICs mentioned below. The secondary market in BaLTICS will allow buyers to purchase BaLTICs for cash as they would a traditional TIC. Further, it will allow users to trade BaLTICs for other BaLTICS or other §1031 property directly, or using a qualified intermediary. Therefore constituting a like-kind tax-free transaction within the meaning of IRC §1031.

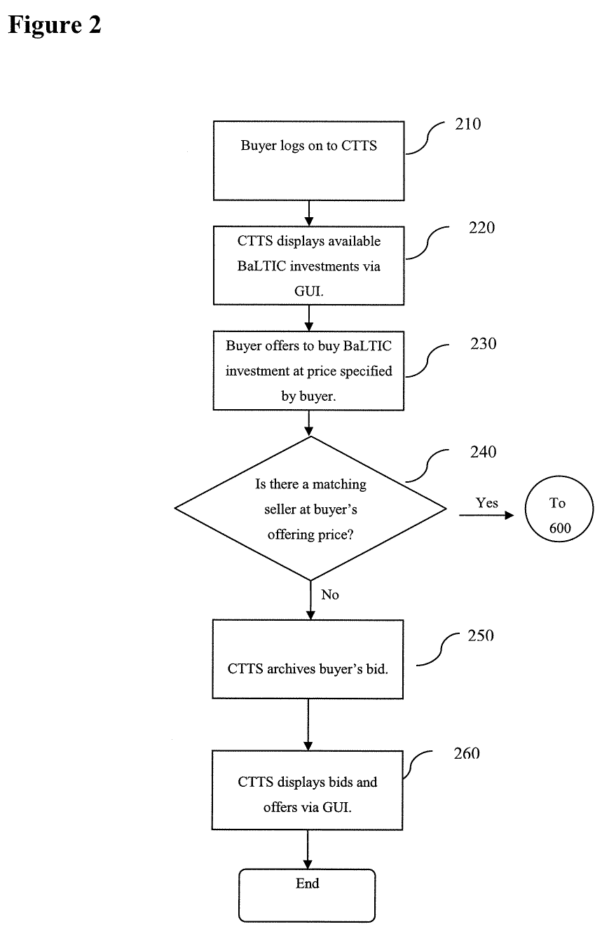

In FIG. 2, the buyer, who has also been previously registered and approved, logs on to the CTTS 210. The CTTS displays the available BaLTIC investment interests via a GUI or other suitable interface 220. The buyer then makes an offer to buy a specific BaLTIC investment at a specific price 230. The CTTS compares the bid made by the buyer to the offers made by all sellers of that particular investment 240. If there is no interest of that type offered at that price, the transaction fails. However, the CTTS creates a record of the bid 250.

The CTTS then makes information about the bid available to all buyers and sellers via a GUI or other suitable interface 260. This allows both buyers and sellers to see the “spread” on investments. The spread is the difference between the lowest price any seller is willing to sell a particular real estate investment for (in this case a BaLTIC investment) and the highest price any buyer is willing to pay for said real estate investment. If the buyer and seller are generally close to striking a deal, the spread will allow either the buyer to increase his bid, or the seller to decrease his offer, or both, until there is a “meeting of the minds”.

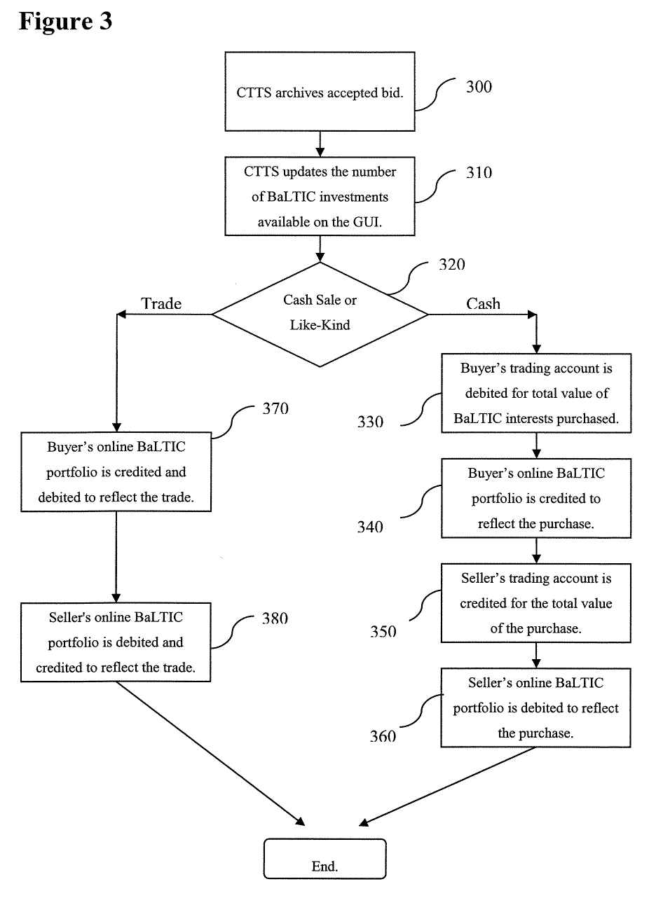

In FIG. 3, when there is a meeting of the minds, the CTTS accepts the buyer's bid 300. The CTTS then updates the number of interests of that particular investment on the GUI or other suitable interface 310. In one embodiment, if the remaining number of TIC interests becomes zero due to the present transaction, that investment is removed from the list for clarity. In an alternative embodiment, if interests of that particular investment are still available, previous sales are archived and may be made available to users via the GUI or other suitable interface to facilitate future sales.

In one embodiment, one of the requirements of registration is that the users provide bank account or credit card information to the central organizing body. To that end, when a sale is completed in 300 the CTTS automatically debits the funding source of the buyer for the total value of the BaLTIC investment(s) purchased 330. In one embodiment, the CTTS also charges the buyer a real estate transaction fee. The transaction fee may be a flat fee, a flat fee per interest, or may be a fee based on a percentage of the total sale. The CTTS then credits the buyer's online BaLTIC portfolio to reflect the number of interests purchased 340.

In one embodiment, the organizing body for the trading system may hold the funds for a number of days in order to ensure the availability of funds from the buyer. In another embodiment, the organizing body for the trading system may hold the funds for a number of days to take advantage of the “float” in lieu of, or in addition to, transaction based fees. Float is defined as holding money for a certain period to use it in a way that is advantageous to the holder, such as to earn interest for example. Once the transaction has been completed with the buyer, the seller's bank and/or credit card account can be credited for the sale 350. In one embodiment, the CTTS also charges the seller a transaction fee. The transaction fee may be a flat fee, a flat fee per interest, or may be based on a percentage of the total sale. Finally, the seller's online BaLTIC portfolio is debited for the number of interests sold 360.

In another embodiment, the buyer and seller may wish to perform a like-kind trade of BaLTICs of equal value. Take, for example, a buyer who wishes to trade interests in BaLTIC A for interests of an equivalent value of interests in BaLTIC B. The BaLTIC portfolio of the buyer is debited the appropriate number of interests of A and credited the appropriate number of interests of B 370. Of course, the offsetting transaction for the seller is that his account is credited interests of A and debited interests of B 380. This like-kind transaction may allow buyers and sellers to diversify their portfolio while availing themselves to favorable tax treatment under IRC §1031.

In another embodiment, the seller may use a qualified intermediary (“QI”) to facilitate a like-kind transaction rather than using an outright exchange. This allows the seller to sell the property, and replace it within 180 days, while still receiving like-kind treatment by the IRS. For instance, the seller enters into an agreement with a QI before sale of property A. The agreement assigns the sellers rights in property A to the QI. At the closing of the property, the QI is listed as the seller. The QI takes the proceeds from the sale and places it in an escrow account. This is generally an insured money market account, or similarly liquid and secure investment. The seller must then declare intent to purchase property B within 45 days and close on property B within 180 days. At the closing, the QI is listed as the buyer. The QI uses the funds in the escrow account to purchase property B. The QI then assigns his rights to the buyer after closing. The buyer then files form 8824 with the IRS and receives §1031 treatment for the deferred exchange.

In one embodiment of the current invention, TIC interests, slice of a whole or bifurcated, are bought and sold over an electronic network facilitated by a central controlling entity. The system is run by an organization that allows users to register to use the service. This registration may include gathering necessary information about buyers and sellers including, but not limited to, name, address, bank account information, credit card information, etc. The central organization may additionally require participants to meet certain credit worthiness requirements.

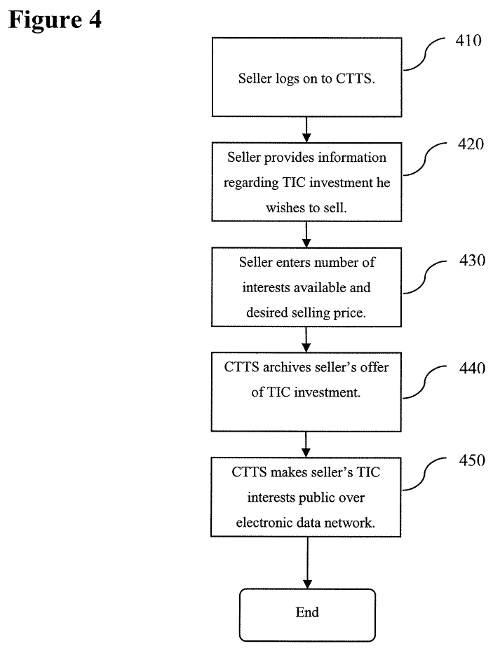

As shown in FIG. 4, the seller begins the process by making one or more interests in a TIC investment available over a centralized TIC trading system (CTTS). The seller, who has registered with the service, first logs onto the system 410. The seller then provides as much information about the property as he desires. At a minimum, the seller provides the information required by the sanctioning body. The information provided may be limited to the location of the property. However, the seller may include such additional information as the address of the property, whether the TIC investment is whole or bifurcated, the type of property, the type of rights for sale (e.g. real, mineral, fossil fuel, etc.), the name of the management company, etc. The seller may also wish to post further information such as previous financial performance, pictures of the property, the history of the property, and so on.

The seller then enters the number of interests for sale and the price per interest 420. The CTTS creates a record including the information provided by the seller, the number of interests for sale, and the price per interest 440. The CTTS then makes this information available to other registered users over an electronic network via a graphical user interface (GUI) or by other suitable means 450. The CTTS thus creates a list of TIC investments available for sale. This list is available to all registered users. In a specific embodiment, in order to make selection of desirable or appropriate properties more efficient for buyers, the list may be sortable by any number of parameters including, but not limited to, price, location, or number of interests available.

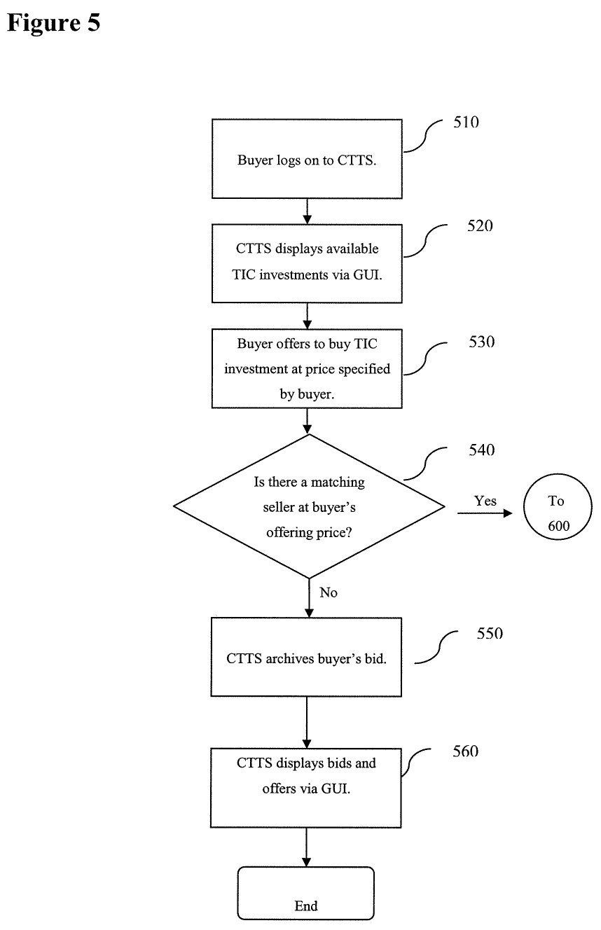

In FIG. 5, the buyer, who has also been previously registered and approved, logs on to the CTTS 510. The CTTS displays the available investment interests via a GUI or other suitable interface 520. The buyer then makes an offer to buy a specific TIC investment at a specific price 530. The CTTS compares the bid made by the buyer to the offers made by all sellers of that particular investment 540. If there is no interest of that type offered at that price, the transaction fails. However, the CTTS creates a record of the bid 550.

The CTTS then makes information about the bid available to all buyers and sellers via a GUI or other suitable interface 560. This allows both buyers and sellers to see the “spread” on investments. The spread is the difference between the lowest price at which any seller is willing to sell a particular real estate investment (in this case a TIC investment) and the highest price any buyer is willing to pay for said real estate investment. If the buyer and seller are generally close to striking a deal, the spread will allow either the buyer to increase his bid, or the seller to decrease his offer, or both, until there is a “meeting of the minds”.

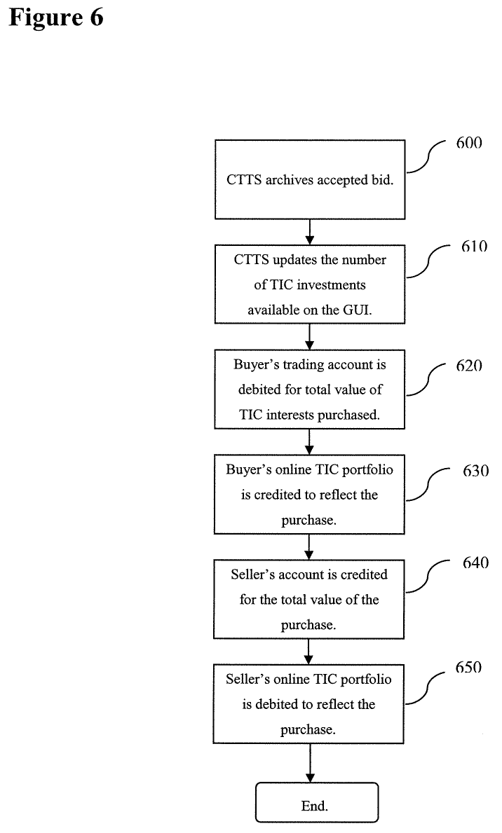

In FIG. 6, when there is a meeting of the minds, the CTTS accepts the buyer's bid 600. The CTTS then updates the number of interests of that particular investment on the GUI or other suitable interface 610. In one embodiment, if the remaining number of TIC interests becomes zero due to the present transaction, that investment is removed from the list for ease of use. In an alternative embodiment, if interests of that particular investment are still available, previous sales are archived and may be made available to users via the GUI or other suitable interface to facilitate research and future sales.

In one embodiment, one of the requirements of registration is that the users provide bank account or credit card information to the central organizing body. To that end, when a sale is completed in 600 the CTTS automatically debits the funding source of the buyer for the total value of the TIC investment(s) purchased 620. In one embodiment, the CTTS also charges the buyer a transaction fee. The transaction fee may be a flat fee, a flat fee per interest, or may be a fee based on a percentage of the total sale. The CTTS then credits the buyer's online TIC portfolio to reflect the number of interests purchased 630.

In one embodiment, the organizing body for the trading system may hold the funds for a number of days in order to ensure the availability of funds from the buyer. In another embodiment, the organizing body for the trading system may hold the funds for a number of days to take advantage of the “float” in lieu of, or in addition to, transaction based fees. Float is defined as holding money for a certain period to use it in a way that is advantageous to the holder, such as to earn interest for example. Once the transaction has been completed with the buyer, the seller's bank and/or credit card account can be credited for the sale 640. In one embodiment, the CTTS also charges the seller a transaction fee. The transaction fee may be a flat fee, a flat fee per interest, or may be based on a percentage of the total sale. Finally, the seller's online TIC portfolio is debited for the number of interests sold 650.

In a further embodiment, the CTTS may provide additional services common to secondary markets to make the exchange more attractive to investors. The CTTS may provide analysis of certain types or locations of investments. This analysis may take the form of statistical or graphical analysis, or analysis by experts provided by the organizing body. The CTTS may additionally offer facilities for other services such as put and call options. There may also be a traditional futures type market in TIC investments.

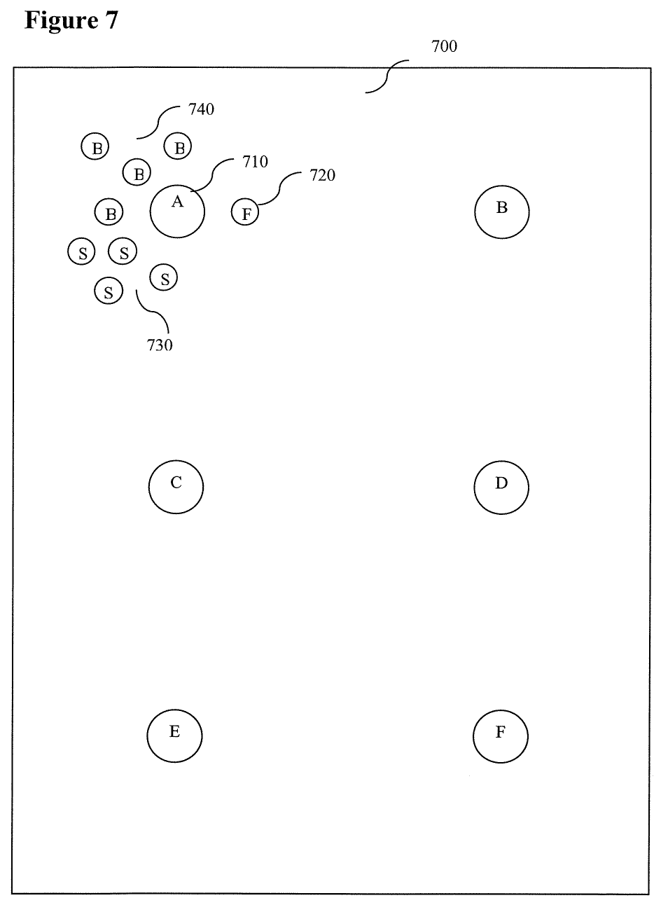

In a further embodiment, the exchange may take the form of a traditional brick and mortar type exchange, such as the floor of the New York Stock Exchange (NYSE). An example of this type of layout is shown in FIG. 7. In this embodiment, buyers and sellers gather in specified areas of the trading floor 700. For instance, buyers and sellers wishing to purchase or sell TIC investment interests in property “A” gather in the area of the floor designated for trading property “A” 710. This area may also be designated for more than one property or type of right. For instance, it may be designated to trade all the rights of a certain property, e.g. real, mineral, structural, etc. Alternatively, it may be designated to trade a certain type of right, e.g. mineral rights, for a multitude of properties. There may also be separate trading areas for bifurcated land and slice of a whole TIC interests.

Trading takes place in an open-outcry type of auction such as would be found on the floor of the NYSE. A special trader, known as a specialist broker 720, acts as a facilitator and auctioneer between the buyers 740 and sellers 730. The buyers 740, sellers 730, and specialist broker 720 use hand signals and yell commands as the auction progresses to indicate buy or sell commands, or to make their bids known to the group. This open outcry system allows for efficient price discovery on the trading floor. Transactions may be completed, once there is a meeting of the minds, using traditional paper “chits” between buyer and seller. In another embodiment, traders may be equipped with handheld electronic devices to record the transactions.

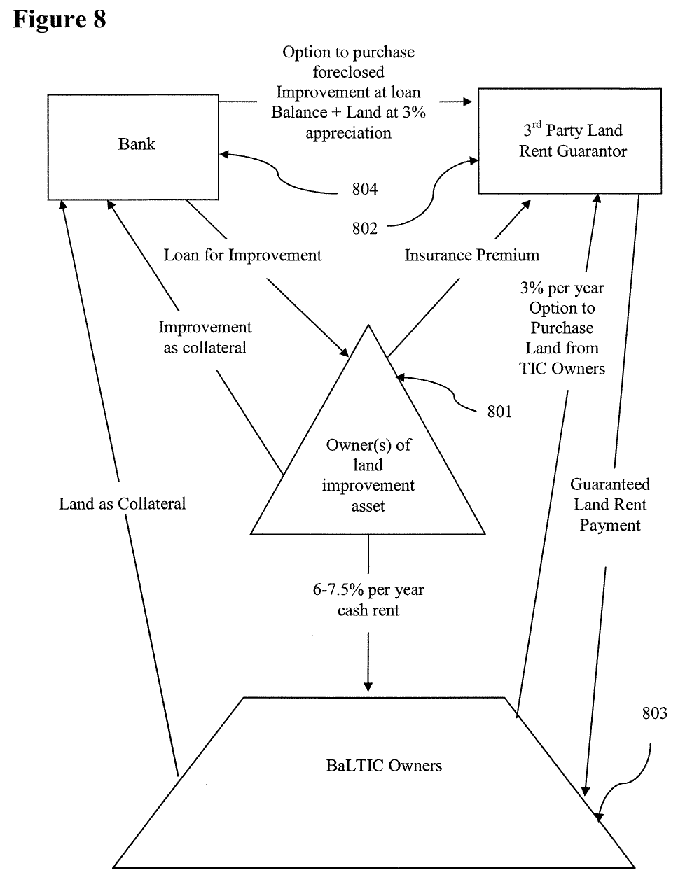

In yet another embodiment, the parties may wish to purchase a type of insurance policy from a third-party guarantor to further separate the land from the land improvements, and thus the “efforts of others”. The policy may be purchased by the land improvement asset owner, the BaLTIC owners, the bank, or any combination therein. As shown in FIG. 8, the owner or owners of the land improvement assets 801, for example, may wish to purchase an insurance policy from a third party land rent guarantor (“guarantor”) 802. The guarantor 802 may be an insurance company, a large real estate brokerage, or a pension fund.

In the event the land improvement asset owner 801 is unable to pay the rent on the land that is owed to the BaLTIC owners 803 as part of the bifurcated land TIC agreement, the guarantor 802 pays the rent for a certain period, as detailed in the policy. The guarantor 802 charges a premium in consideration of the possibility that the land improvement asset owner 801 will be unable to meet his rent obligations.

Additionally, after the period detailed in the policy, the guarantor 802 may have the option to purchase the land improvement asset from the funding provider (“bank”) 804. Further, if the guarantor deems the property more valuable in non-bifurcated form, the guarantor 802 may have the option to buy the land from the BaLTIC owners 803.

This type of insurance policy effectively lowers the risk for the BaLTIC owners 803 with respect to rent payments. In the event if a short-term failure to pay rent by the land improvement asset owner 801, the guarantor 802 pays the rent directly to the BaLTIC owners 803 for a finite time period set forth in the policy. This period may be, for example six months, one year, or two years. This also means that the rent on the land will be paid regardless of the “efforts of others,” namely the land asset improvement owner 801. This, inter alia, makes it less likely the SEC will classify this type of investment as a security.

In consideration for the purchase of this type of insurance, and the lowered risk it provides, the BaLTIC owners 803 may be willing to subordinate their rights in the land to the bank 804. In other words, the BaLTIC owners 803 may pledge a portion, or all, of their land to secure the loan on the land improvement asset. For instance, the BaLTIC owners 803 may pledge a percentage of their land to secure the loan for the land improvement asset based on a loan-to-value ratio. In one embodiment, the loan-to-value ratio may be established by the bank's lending guidelines. Alternatively, the loan-to-value ratio may be a requirement set forth by the BaLTIC agreement.

For example, in one embodiment, the maximum loan-to-value ratio may be 50%. This means, by way of example only, that if the BaLTIC owners 803 wished to secure $50,000 worth of debt, they would pledge $100,000 worth of land to secure it. Therefore, the land improvement asset owner 801 would have $50,000 more collateral available to secure the loan than he would have had otherwise, thus effectively increasing his credit worthiness. At the same time, the BaLTIC owners 803 risk no more than 50% of their land in the pledge agreement.

This increases the risk for the BaLTIC owners 803 in the event of bank foreclosure. However, this subordination also allows the bank 804 to lend more money to the land improvement asset owner 801. This, in turn, allows the land improvement asset owner 801 to use that additional money to his advantage, e.g., to build a more expensive, expansive, or additional land improvement assets. As a result, the BaLTIC owners 803 may be in a position to demand, and the land improvement asset owner 801 may be willing to pay, a higher rental rate, and/or a higher appreciation cost on the land.

On the other hand, if land improvement asset owner 801 is unable to meet his rent obligations and does not resume rent payments within the period defined in the policy, the guarantor 802 may exercise one or both of its purchase options. Assuming, of course, that it is financially advantageous to do so, the guarantor 802 may purchase the land improvement asset from the bank 804 under the terms set forth in the agreement. In one embodiment, the guarantor 802 may be able to purchase the land improvement asset for the remaining balance of the loan. If the principle on the loan has been paid down, but the land improvement asset has maintained its value or appreciated, this may be an advantageous purchase indeed.

Additionally, the guarantor 802 may also wish to exercise the option to purchase the land from the BaLTIC owners 803. If so, the BaLTIC owners 803 can be bought out according to the terms of the BaLTIC agreement. In one embodiment, the BaLTIC owners may be paid their original purchase. In another embodiment, they may be paid their original purchase price plus a fixed fee. In yet another embodiment, they may be paid their original purchase price and an annual appreciation rate tied to an index or other indicator, such as the prime rate or LIBOR. In yet another embodiment, they may be paid their original purchase price plus a fixed annual appreciation rate. In one embodiment, they may be paid their original purchase price plus a fixed percentage of, for example, 1, 2, or 3 percent, compounded annually.

However, in some limited instances, the risk to the BaLTIC owners 803 may become unfavorable. If the land improvement asset owner 801 fails to make rent payments for the specified period and the guarantor 802 does not wish to exercise the option to purchase, the bank 804 may be forced to foreclose on the land improvement asset. Additionally, if the balance due on the loan is larger than the value of the land improvement asset, the bank 804 may also be forced to foreclose on the portion of the value of the BaLTIC shares pledged to secure the debt. Therefore, the BaLTIC owners 803 are faced with the possibility of losing the amount of their investment pledged to secure the debt.

However, the addition of a guarantor 802 beneficially changes the dynamic of the BaLTIC investment. The guarantor 802 charges an actuarially sound premium for said insurance based on, among other things, the past performance and stability of the land improvement asset owner 801, the quality of the improvement, and quality of the land itself. The guarantor might also look at present and past projects, if applicable, credit reports, etc. of the land improvement asset owner 801 to arrive at a premium. Additionally, the third-party guarantor 802 may be an insurance company or a large real estate firm that will be able to take advantage of short-term instability in the market. Therefore, the guarantor also gains the possibility of making a substantial profit by exercising the option to buy the land improvement asset and/or the land itself should the land improvement asset owner 801 fail to pay rent for the specified period.

On the other hand, the addition of a guarantor gives the improvement asset owner 801 increased equity and marketability. The addition of the guarantor 802 reduces or eliminates the risk that the BaLTIC owners 803 will not receive continuing rent payments. This makes BaLTIC shares more enticing to investors looking for low risk, steady return investments. Additionally, because the BaLTIC owners 803 may be willing to pledge a portion of the land to secure financing, the land improvement asset owner 801 will be able to obtain a larger loan from the bank 804. This, in turn, translates to potentially larger land improvement assets, potentially larger profits for the land improvement asset owner, and potentially larger rent payments to the BaLTIC owners 803.

The addition of a guarantor 802 also makes possible negotiation between the BaLTIC owners 803 and the land improvement asset owner 801 regarding the BaLTIC agreement. This allows resources to be used in a highly efficient manner. The parties can use payment of the insurance policy premium, length of coverage, and payout details as factors while structuring the BaLTIC agreement and other agreements. For example, an insurance policy with longer-term coverage, say two years instead of one, may encourage the BaLTIC owners 803 to pledge a higher percentage of their land to secure a loan for the land improvement asset.

The benefits to the BaLTIC owners 803 and the land improvement asset owner 801 for obtaining this type of insurance policy are detailed above. However, there may also be situation where the BaLTIC owners 803, the land improvement asset owner 801, and/or the bank 804 would share the cost of the policy for their mutual benefit. For instance, the policy may allow the bank 804 to satisfy certain underwriting requirements for the loan. Alternatively, the added collateral provided by the BaLTIC owners may allow the bank 804 to write a larger loan. This is, in itself, generally advantageous to banks, as a few large loans require fewer resources to underwrite and administer than many small loans. Therefore, the terms and conditions of the policy may act as an additional point of negotiation to ease loan approval or increase the amount of the loan.

In yet another embodiment, the secondary market in bifurcated land and slice of a whole tenant in common real property interests is created as both an electronic market and a physical market in a specified location. The information created by both the CTTS and the public outcry auction is combined to provide buyers and traders using both methods almost instantaneous market information. This embodiment allows for both the efficient price discovery of a trading floor and the high volume afforded by an electronic exchange.

In still another embodiment of the present invention, unimproved land and surface and sub-surface mineral rights are legally bifurcated from the improvements on the land. In this manner, BaLTIC interests can be sold as a pure land investment. As a result, the SEC should not classify these interests as a security. This reduces the amount of paperwork and oversight involved for both the promoter and the investor. Additionally, IRC §1031 allows the exchange of like-kind property tax free. Moreover, under Internal Revenue Procedure 2002-22, TICs with less than 35 members will not be taxed at the partnership level, thus preventing double taxation to interest owners. Finally, BaLTIC real estate investments, because they contain no business interest, should not be limited by the 35 investor rule in Rev. Proc. 2002-22.

Additionally, slice of the whole TIC investments have traditionally been treated as securities. As a result, TIC investments are generally traded by securities brokers. However, because the land has been legally bifurcated from the land improvement assets, a BaLTIC share is a pure real estate investment. BaLTICs move TIC investments out of the security arena and into the real estate arena.

This distinction is further strengthened with the addition of the third-party guarantor. The use of a third-party guarantor essentially takes the risk out of the investment for the BaLTIC owners. Therefore, because the investment is guaranteed, the use of a third-party guarantor removes a crucial element to the classification of investments as securities, to with, “the efforts of others”.

The possible classification of BaLTICs as real estate investments rather than securities would be beneficial for the real estate market. Real estate agents would have a new and viable product to add to offer their clients looking for a pure land investment, or steady and secure source of income and appreciation. Indeed, with over 1 million National Association of Realtors agents alone, there is a vast sale network already in place.

The present invention provides a variety of methods for creating an efficient and successful secondary market in tenant in common real property interests. By creating a centralized system, the present invention de-fractionalizes the secondary market in tenant in common real property interests. The present invention also provides a secure and reliable method for buying and selling tenant in common real property interests. The methods may include a traditional brick and mortar type of physical exchange or a purely electronic exchange over an electronic data network. The present invention may also advantageously incorporate elements of both methods to provide a close to ideal secondary market.

While specific embodiments of the present invention have been described, other and further modifications and changes may be made without departing from the spirit of the invention. All further and other modifications and changes are included that come within the scope of the invention as set forth in the claims. The disclosures of all publications cited above are expressly incorporated by reference in their entireties to the same extent as if each were incorporated by reference individually.

What is claimed is:

1. A method comprising:
obtaining an insurance policy that guarantees land rent payments from the owners of a land improvement asset to the owners of bifurcated land TIC interests on land subject to a bifurcated land TIC agreement.

2. The method of claim 1, wherein said insurance policy is purchased from a third-party guarantor by one or more parties selected from the group consisting of land improvement asset owners, bifurcated land TIC interest owners, and funding providers.

3. The method of claim 2, wherein said third-party guarantor comprises one or more entities selected from the group consisting of real estate brokerages, investment banks, insurance companies, and pension funds.

4. The method of claim 2, wherein said third-party guarantor has the option to purchase said land improvement asset for the remaining loan balance when said land improvement asset owner fails to pay said land rent for a period specified in the policy.

5. The method of claim 4, wherein said third-party guarantor has the option to purchase said bifurcated land TIC interests for the original purchase price plus a fixed annual percentage rate after exercising the option to purchase said land improvement asset.

6. The method of claim 4, wherein said bifurcated land TIC interest owners have the option to purchase said land improvement asset for the remaining loan balance when said third-party guarantor declines to exercise said option to buy said land improvement asset.

7. A method comprising:
obtaining financing for a land improvement asset on land subject to a bifurcated land TIC agreement, wherein said land improvement asset is subject to a land lease on said land; and
obtaining an insurance policy that insures land rent payments from the owners of said land improvement asset to owners of said bifurcated land TIC interests in the event there is a default on said financing or a failure to pay said rent by said land improvement asset owner.

8. The method of claim 7, wherein the financing is secured using said land improvement asset and up to 50 percent of the value of said bifurcated land TIC interests.

9. The method of claim 7, wherein said insurance policy is purchased from a third-party guarantor by one or more parties selected from the group consisting of land improvement asset owners, bifurcated land TIC interest owners, and funding providers.

10. The method of claim 9, wherein said third-party guarantor is one or more entities selected from the group consisting of real estate brokerages, investment banks, insurance companies, and pension funds.

11. The method of claim 9, wherein said third-party guarantor has the option to purchase said land improvement asset for the remaining loan balance if said land improvement asset owner fails to pay said land rent for a period specified in the policy.

12. The method of claim 11, wherein the third-party guarantor has the option to purchase the bifurcated land TIC interests for the original purchase price plus a fixed annual percentage after purchasing said land improvement asset for the remaining loan balance.

13. The method of claim 11, wherein said bifurcated land TIC interest owners have the option to purchase said land improvement asset for the remaining loan balance if said third-party guarantor declines to exercise the option to purchase said land improvement asset.

14. A method comprising:
selling an insurance policy that guarantees land rent payments from the owners of a land improvement asset to owners of bifurcated land TIC interests on land subject to a bifurcated land TIC agreement.

15. The method of claim 14, wherein said insurance policy is sold by a third-party guarantor to one or more parties selected from the group consisting of land improvement asset owners, bifurcated land TIC interest owners, and funding providers.

16. The method of claim 15, wherein said third-party guarantor comprises one or more entities selected from the group consisting of real estate brokerages, investment banks, insurance companies, and pension funds.

17. The method of claim 15, wherein said third-party guarantor has the option to purchase the land improvement asset for the remaining loan balance when said land improvement asset owner fails to pay said land rent for a period specified in the policy.

18. The method of claim 17, wherein said third-party guarantor has the option to purchase said bifurcated land TIC interests for the original purchase price plus a fixed annual percentage rate after exercising the option to purchase said land improvement asset.

19. The method of claim 17, wherein said bifurcated land TIC interest owners have the option to purchase said land improvement asset for the remaining loan balance when said third-party guarantor declines to exercise said option to buy said land improvement asset.
